(19) United States
(12) Patent Application Publication
(10) Pub. No.: US 2025/0183784 A1
(43) Pub. Date: Jun. 5, 2025

(54) ZERO VOLTAGE SWITCHING CONVERTER

(71) Applicant: UT-Battelle, LLC, Oak Ridge, TN (US)

(72) Inventor: Rajendra Prasad Kandula, Knoxville, TN (US)

(21) Appl. No.: 18/968,610

(22) Filed: Dec. 4, 2024

Related U.S. Application Data
(60) Provisional application No. 63/605,691, filed on Dec. 4, 2023.

(51) Int. Cl. H02M 1/00; H02M 7/219

(52) U.S. Cl. CPC H02M 1/0058; H02M 1/007; H02M 7/219

(57) ABSTRACT

A converter building block for an AC-DC or DC-AC converter according may be provided and configured for soft switching across an operating range while operating under fixed frequency.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF INVENTION

The present disclosure relates to the field of power conversion, and more particularly to a zero-voltage switching converter.

### BACKGROUND

Use of a non-isolated DC-AC converter is a requirement in several applications, such as photovoltaics, storage, and electric drives, etc. In addition, a 1-phase AC-DC converter is one of the main building blocks in cascaded H-bridge based medium-voltage (MV) converters. One type of conventional AC-DC converter uses Si IGBTs for switching circuitry, and such AC-DC converters are often operated in the range of 5-20 kHz. The advent of SiC MOSFETs and their use in conventional AC-DC converts has enabled operation at greater than 20 kHz. However, the upper bound on switching frequency is still dictated by the switching loss and the dv/dt induced noise. Switching loss can be reduced through soft switching approaches, including either zero-voltage-switching (ZVS) or zero-current-switching (ZCS). However, ZVS is required to address dv/dt related issues.

Conventionally, there are two basic approaches to implement a ZVS AC-DC converter. The first conventional approach relies on additional auxiliary resonant circuits on the DC side, as shown in FIG. 1A. The resonant stage of the converter in FIG. 1A increases the blocking voltage of the main switches to 1.1 pu (per unit). The converter is bidirectional, but the power factor is restricted to +/−π/3. A modified switching scheme to increase the control region to +/−π/2 has been discussed, but this approach involves increasing the switching frequency Fₛ of the main switches.

The second conventional approach for a ZVS AC-DC converter is shown in FIG. 1B, and relies on zero voltage transition (ZVT) by controlling filter inductor current to oscillate between opposite polarities such that the main switches are turned-on when current is flowing in the corresponding anti-parallel free-wheeling diode (FWD), as shown in FIG. 1B. This ZVT method does not include any auxiliary circuits but uses a variable frequency-based method called triangular current modulation (TCM) technique to achieve ZVS. The switching frequency can vary from 1× to 15×. The variation in the switching frequency Fₛ can be limited to 3×. With TCM, the current ripple increases to 200% compared to 5-10% in other conventional AC-DC converters, resulting in a smaller inductor. However, this means an increase in the size of the filter capacitor. Interleaving may be used to limit the capacitor size but achieving interleaving with variable frequency adds significant complexity to the converter.

### SUMMARY

In general, one innovative aspect of the subject matter described herein is a converter module that includes a half bridge including a first switch and a second switch. The converter module may include a filter inductor electrically connected at the output of the half bridge, and an auxiliary switching circuit electrically connected in parallel to the filter inductor. The auxiliary switching circuit may include a pair of switches having their emitters electrically connected to each other or having their collectors electrically connected to each other, where the auxiliary switching circuit may be configured to cause, when the converter module is operated using fixed-switching frequency, zero-voltage switching of the first switch or the second switch or both.

The foregoing and other embodiments can each optionally include one or more of the following features, alone or in combination. In particular, one embodiment includes all the following features in combination.

In some embodiments, a first filter capacitor may be electrically connected in parallel across the first switch and the filter inductor.

In some embodiments, an input may be operable to receive power from a power source, where the input may be operably coupled to the half bridge to supply power thereto, and where a load may be operably coupled to the half bridge to receive power therefrom.

In some embodiments, a second filter capacitor may be electrically connected in parallel across the second switch and the filter inductor.

In some embodiments, the output may be operable to receive power from a power source via the filter inductor and the auxiliary switching circuitry, and where the converter may be operable to supply power across the first and second switches of the half-bridge.

In some embodiments, the converter may be bidirectional such that the output of the half-bride is operable to receive and supply power.

In some embodiments, the half bridge may be operable to receive AC power from a power source, and where the half bridge may be operable to generate DC power.

In some embodiments, each of the switches includes a MOSFET or an IGBT, and an antiparallel free-wheeling diode.

In some embodiments, the converter may be controlled using a dead-beat predictive model.

In some embodiments, the converter may be controlled according to a dead-beat predictive module once every switching cycle.

In some embodiments, the converter may be operated according to a buck mode or a boost mode.

In some embodiments, a 1-phase converter comprising two cascaded copies of the converter module.

In some embodiments, the half bridge of each of the converters may be operable to receive AC power from a power source, and wherein the half bridges are operable to generate DC power.

In some embodiments, three copies of the converter module may be provided, where the converters may be electrically connected in parallel to each other.

In some embodiments, the half bridge of each of the converters may be operable to receive AC power from a power source, and wherein the half bridges are operable to generate DC power.

In general, one innovative aspect of the subject matter described herein is a converter module for converting AC power to DC power. The converter module may include a half bridge including a high side switch and a low side switch. The high side switch may be operably coupled to the low side switch via a first node. The half bridge may be operable to at least one of receive and supply the DC power.

The converter may include an inductor electrically coupled to the first node of the half bridge. The inductor may include operable to at least one of direct the AC power from a power source to the first node and supply the AC power from the first node to a load.

The converter may include an auxiliary switching circuit electrically connected in parallel to the inductor. The auxiliary switching circuit may include a first switch operable to facilitate selective bypassing of the inductor.

The converter module may be configured such that the half bridge is operable to supply the DC power based on power received via the first node, and wherein, the auxiliary switching circuit is operable facilitate selective bypassing of the inductor to direct the AC power from the power source to the first node.

The foregoing and other embodiments can each optionally include one or more of the following features, alone or in combination. In particular, one embodiment includes all the following features in combination.

In some embodiments, the auxiliary switching circuit may include a second switch electrically connected in series with the first switch, where a source of each of the first and second switches may be connected together.

In some embodiments, the auxiliary switching circuit may include a second switch electrically connected in series with the first switch, where the first and second switches may be connected in one of a common collector configuration or a common emitter configuration.

In some embodiments, the auxiliary switching circuit may be configured to cause, when the converter module is operated using fixed-switching frequency, zero-voltage switching of at least one of the high and low side switches of the first half bridge.

In some embodiments, a controller configured to direct operation of the first half bridge and the auxiliary switching circuit.

In some embodiments, a second half bridge may include a second high side switch and a second low side switch. The second high side switch may be operably coupled to the second low side switch via a second node.

In some embodiments, a second inductor may be electrically coupled to the second node of the second half bridge. The second inductor may be operable to direct the AC power from the power source to the second node.

In some embodiments, a second auxiliary switching circuit may be electrically connected in parallel to the second inductor. The second auxiliary switching circuit may be operable to facilitate selective bypassing of the second inductor to direct the AC power from the power source to the second node.

In some embodiments, a third half bridge may include a third high side switch and a third low side switch. The third high side switch may be operably coupled to the third low side switch via a third node.

In some embodiments, a third inductor may be electrically coupled to the third node of the third half bridge. The third inductor may be operable to direct the AC power from the power source to the third node.

In some embodiments, a third auxiliary switching circuit may be electrically connected in parallel to the third inductor. The third auxiliary switching circuit may be operable to facilitate selective bypassing of the third inductor to direct the AC power from the power source to the third node.

In some embodiments, a low side switch, the second low side switch, and the third low side switch may be connected at a common node.

In some embodiments, a high side switch, the second high side switch, and third low side switch may be connected at a DC output. The DC power may be supplied via the common node and the DC output.

In some embodiments, the second and third auxiliary switching circuits may include first and second auxiliary switches connected in a common emitter configuration or a common collector configuration.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 shows a conventional converter.

FIG. 2 shows a converter system according to one embodiment.

FIG. 3 shows a converter system according to one embodiment.

FIG. 4 shows a timing diagram of operation according to one embodiment.

FIG. 5 shows a timing diagram of operation according to one embodiment.

FIG. 6 shows a control methodology according to one embodiment.

FIG. 7 shows a converter system according to one embodiment.

FIG. 8 shows a converter system according to one embodiment.

FIG. 9 shows results of operation according to one embodiment.

FIG. 10 shows results of operation according to one embodiment.

FIG. 11 shows results of operation according to one embodiment.

FIG. 12 shows results of operation according to one embodiment.

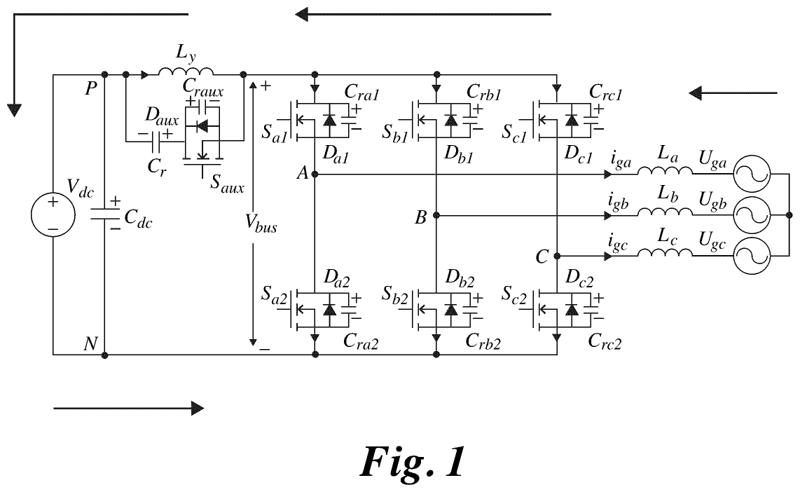

### DESCRIPTION

A converter building block (e.g., a half-bridge building block) for an AC-DC or DC-AC converter according to one embodiment may be provided and configured for soft switching across an operating range while operating under fixed frequency.

Additionally, or alternatively, a dead-beat model predictive control methodologies may be used to control the AC-DC converter. The converter according to one embodiment, referred to as zero-state modulated (ZSM) converter, may use a zero state, enabled by an auxiliary switch or bypass switch, to achieve soft-switching. The configuration may enable lower switching loss, controlled dv/dt, a small filter inductor, and fixed frequency operation allowing interleaving to reduce the filter capacitor size. The switching circuit topology in one embodiment includes a single half-bridge building block operable to implement a zero-voltage switching (ZVS) DC-DC converter, or one or more of these building blocks can be used to achieve soft switching 1-phase or 3-phase AC-DC converters.

A half-bridge circuit 101 according to one embodiment can achieve ZVS across an operating range (e.g., a complete operating range) while operating under fixed frequency. Multiple of these half-bridge building blocks can realize ZVS AC-DC. The schematic, operating principle, and control algorithm based on dead-beat model predictive controls are disclosed. The half-bridge circuit 101 may enable reduced size, cost, and performance over conventional ZVS AC-DC systems.

### I. Overview of Converter Circuitry

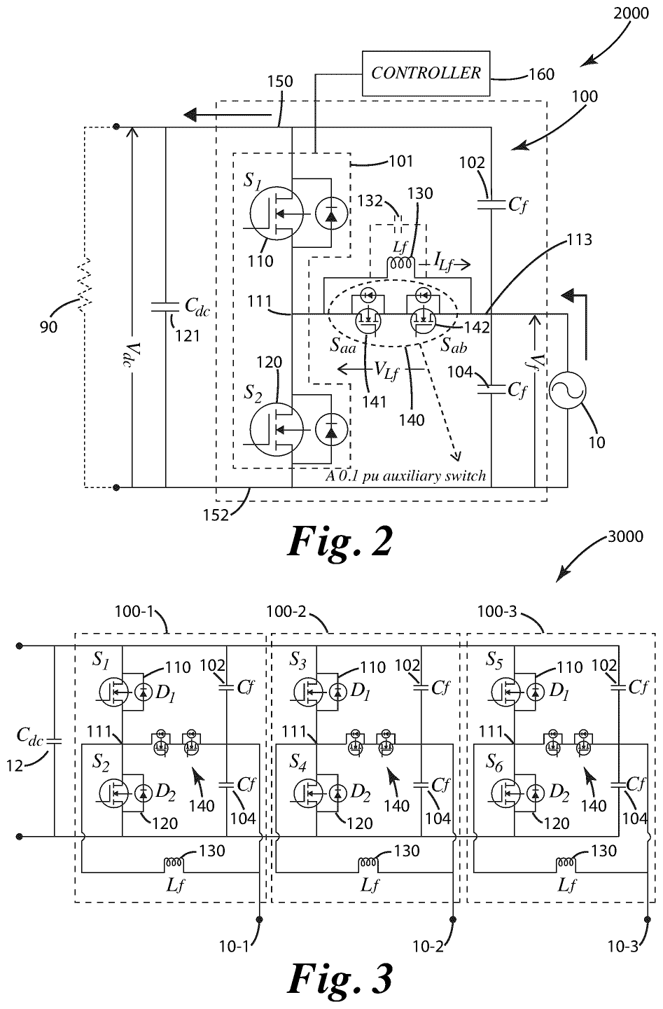

A converter circuit according to one embodiment is shown in FIG. 2 and generally designated 100. The converter circuit 100 according to one embodiment is operable to convert AC power to DC power for a variety of applications. For instance, the converter 100 may receive power from an AC power source 10 and convert this AC power to DC power for supply to a DC load 90, which may be any type of component or device configured to receive DC power. The AC power source 10 may be any type of power source, for instance, including single-phase grid power and multiple-phase grid power. For purposes of disclosure, a capacitor 12 is shown coupled to the DC output 150 of the converter 100. The capacitor 12 may be a bulk capacitor and/or a filter capacitor operable to facilitate supply of DC power to the DC load 90. The converter 100 in the illustrated embodiment is part of a converter system 2000 that includes the converter 100, as well as the DC load 90, the capacitor 12, and the AC power source 10.

The converter 100 may include a half-bridge circuit 101 with a plurality of switches that are controllable to generate DC power based on AC power from the AC power source 10. It is to be understood that converter 100 is not limited to a half-bridge circuit 101—any type of switching circuit may be utilized with a plurality of switches operable to generate DC power based on AC power. For instance, a full bridge circuit may be used in place of the half bridge circuit 101.

The half-bridge circuit 101 may be operable in conjunction with a bypass circuit 140 (also described as an auxiliary switch), an inductor 130 (also described as a filter inductor and identified as inductor L_{f}), and filter capacitors 102, 104 (also identified as capacitors C_{f}). The converter 100 in one embodiment may include the half-bridge circuit 101 along with the bypass circuit 140, inductor 102, and filter capacitors 102, 104 to form a basic building block for an electrical system. The auxiliary switch or bypass circuit 140 may be an AC switch connected across the filter inductor 102. The bypass circuit 140 may be implemented by connecting two switches 141, 142 (also described as switches Sₐₐ and S_{ab}) in a common emitter or a common collector configuration or a common source or a common drain configuration. The bypass circuit 140 may be configured to (i) block 1.0 per unit (pu) voltage, and (ii) only handle <0.1 pu of the line current.

The converter 100 may be standalone from a control point of view. This approach allows use of the converter 100 for building multiple different types of configurations, such as a 3-phase 3-wire version, shown in FIG. 3, 1-phase DC/AC inverter, and a 3-ph 4-wire inverter. It is to be understood that, although the converter 100 is described herein in conjunction with AC to DC power conversion, the present disclosure is not so limited and the converter 100 may be operated for DC to AC power conversion.

For instance, the circuit in FIG. 2 may be operable as a DC-to-AC converter by replacing the load 90 with a DC power source and replacing the power source 10 with a load. The converter 100 may be operated to receive power from the DC power source across the half-bridge circuit 101 to generate AC power at the input node 111 (now an output node) for supply to the load via the inductor 130 and the bypass circuit 140. The bypass circuit 140 may be configured to selectively bypass the inductor 130 in the same or similar manner as described herein in conjunction with operation as an AC-to-DC converter. DC-to-AC converter operation may also be achieved with respect to the multiple-phase converter arrangement in FIG. 3 with DC power being supplied to each of the converters 100, and each converter operable to generate AC power with the bypass circuit 140 selectively bypassing the inductor 130.

In one embodiment, the converter 100 may be operated bi-directionally so that, in a first mode, the converter is operated as an AC-to-DC converter (power flowing right to left in FIG. 2 from an AC source to a DC load), and in a second mode, the converter is operated as a DC-to-AC converter (power flowing left to right in FIG. 2 from a DC source to an AC load)

In FIG. 2, the half bridge circuit 101 includes a first switch 110 (also identified as switch S1) and a second switch 120 (also identified as switch S2), which may be considered respectively as a high side switch and a low side switch. The first and second switches 110, 120 may be any type of switch, including but without limitation MOSFETs or IGBTs. In FIG. 2, the first and second switches are MOSFETS including a body diode.

The first and second switches 110, 120 of the half bridge circuit 101 may be controlled in a variety of ways as described herein to generate DC power based on AC power. For instance, control signals may be provided to the first and second switches 110, 120 by a controller 160. These control signals may be supplied to the respective gates of the first and second switches 110, 120. The controller 160 may be absent in some configurations, with active driver circuitry provided instead without the controller 160 to selectively provide control signals to the gates of the first and second switches 110, 120.

The first and second switches 110, 120 may be alternately turned ON in a complementary manner, so that only one switch is ON at a time to avoid a short circuit (also called shoot-through).

In the illustrated embodiment of FIG. 2, the half-bridge 101 of the converter 100 includes an input node 111 to which both the first and second switches 110, 120 are operably coupled for receipt of power from the AC power source 10. Based on selective control over the ON state of the first and second switches 110, 120, current may selectively flow through the first switch 110 between the input node 111 and the DC output 150, and current may selectively flow through the second switch 120 between the input node 111 and the common node 152 (e.g., a ground node).

The converter 100 includes an inductor 130 provided in the flow path between a supply node 113 and the input node 111 of the half-bridge 101. The inductor 130 may filter current flowing between the supply node 113, which is coupled to the AC power supply 10, and the input node 111 of the half-bridge 101. The AC power supply 10, as described herein, may supply AC power to the supply node 113, which the converter 100 may convert to DC power across the DC output 150 and the common node 152.

The converter 100 in the illustrated embodiment is operable to selectively bypass the inductor 130 provided between the supply node 113 and the input node 111 of the half-bridge circuit 101 (e.g., switching circuitry operable to generate DC power based on AC power). Selective bypass of the inductor 130 may be conducted by a bypass circuit 140 (also described as a filter bypass circuit or an auxiliary switch). Control over the bypass circuit 140 may be provided by the controller 160 according to one or more embodiments described herein. Optionally, the bypass circuit 140 may be operated in absence of a controller 160 by a circuitry (not shown) configured to selectively bypass the inductor 130 to facilitate conversion according to one or more embodiments described herein.

The bypass circuit 140 in the illustrated embodiment of FIG. 2 includes first and second bypass switches 141, 142, which may be connected in parallel to the inductor 130 between the supply node 113 and the input node 111 of the half-bridge 101. The bypass circuit 140 may be constructed in a variety of ways capable of selectively bypassing the inductor 130 (or another type of filter element or circuit provided between the supply node 113 and the input node 111). In the illustrated embodiment, the bypass circuit 140 of the converter 100 may include a back-to-back switch configuration for the first and second bypass switches 141, 142 so that, with both switches in the OFF state, the first and second bypass switches 141, 142 substantially prevent current flow in both directions. The back-to-back arrangement may depend on the type of the first and second switches 141, 142. For instance, in the case of MOSFETs for the first and second switches 141, 142, they may be arranged in a common drain or common source configuration. In the case of IGBTs for the first and second switches 141, 142, they may be arranged in a common emitter or common collector configuration. Alternatively, first and second bypass switches 141, 142, can also be implemented using a monolithic bidirectional GaN (Gallium Nitride) switch.

Optionally, a capacitor 132, Cₛ may be provided in parallel to the inductor 130. The capacitor 132 may effectively increase device output capacitance.

The converter 100 in the illustrated embodiment includes first and second capacitors 102, 104 coupled respectively between the supply node 113 and the DC output 150 and the common node 152. The first and second capacitors 102, 104 may be configured to act as filter capacitors providing a path for the switching frequency currents back to the source bus 121.

The controller 160 may include any and all electrical circuitry and components to carry out the functions and algorithms described herein. Generally speaking, the controller 160 may include one or more microcontrollers, microprocessors, and/or other programmable electronics that are programmed to carry out the functions described herein. The controller 160 may additionally or alternatively include other electronic components that are programmed to carry out the functions described herein, or that support the microcontrollers, microprocessors, and/or other electronics. The other electronic components include, but are not limited to, one or more field programmable gate arrays, systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in other manners, whether combined into a single unit or distributed across multiple units. Such components may be physically distributed in different positions of the converter 100, or they may reside in a common location within the converter 100. When physically distributed, the components may communicate using any suitable serial or parallel communication protocol, such as, but not limited to, CAN, LIN, Fire Wire, I2C, RS-232, RS-485, and Universal Serial Bus (USB).

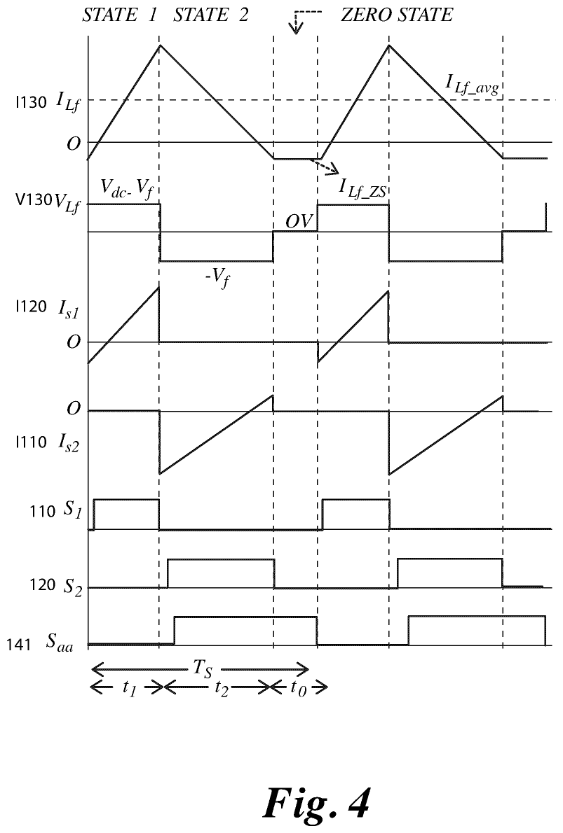

Operation of the converter 100 according to one embodiment is shown in FIGS. 4-6. For purposes of disclosure, operation is described in conjunction with the converter system 2000 in FIG. 2 with an AC power source 10 in the form of a single-phase power source. Operation of the converter 100 for a single-phase system may be substantially the same for a multiple-phase system, with each of the converters 100 in the system, such as the system 3000, operating according to the control methodology for the converter 100 in a single-phase system.

In one embodiment, the operating principle for a converter 100 is a 1-phase or a 3-phase converter with a combination of multiple converter blocks, and each of these blocks operate independently. The operation of the disclosed topology may include operational aspects of a TCM converter except with the addition of zero state. Typically, in a half-bridge converter, a voltage of V_{dc}+V_{f} or −V_{f} is applied across the filter inductor 130. However, with the additional auxiliary switch or bypass switching circuit 130, 0 V can be applied across the filter inductor 130, which hereby is herein referred to as “zero state”. The zero state may allow the converter 100 to operate with a fixed switching frequency Fₛ, which in turn may allow interleaving. In addition, the bias current maintained in the filter inductor 130 during the zero state may ensure ZVS turn-on of the half-bridge circuit 101.

With respect to FIG. 4, operation is described using the converter 100 in FIG. 2, with power being delivered from V_{dc} to V_{f} (e.g., as a DC-to-AC conversion). Examples of corresponding waveforms are shown in FIG. 4.

The initial current in the inductor 130 may be a small negative bias current, I_{Lf_zs}, such as −0.1 pu. At this instant, all the switches 110, 120 of the half-bridge circuit 101 are turned OFF, and the bypass circuitry 140 is turned ON so that the inductor current is flowing through the bypass switch 141 and the FWD of bypass switch 142. At the start of t1, the bypass switch 141 is turned OFF and the current transitions to the FWD of the first switch 110. The bypass switch 141 may have quasi-ZVS turn-off. Since the current is flowing through the corresponding FWD at this point, the switch 110 may have ZVS turn-on. The switch 110 is ON to apply a voltage of (V_{dc}-V_{f}) for a time t1, where V_{dc} is the DC link voltage and V_{f} is the filter capacitor voltage. The inductor current may turn positive and transfer to the switch 110 from its FWD. At the end of t1, the current may reach Iₚₖ. The switch 110 may now be turned OFF with quasi ZVS. The current may transition to FWD of the switch 120. The switch 120 may now be turned ON with ZVS.

In addition, the bypass switch 141 may be turned ON after a short delay. Since the FWD across the bypass switch 141 may be forward biased, the bypass switch 141 may be turned ON with both ZVS and ZCS. The second switch 120 and the bypass switch 141 may be ON until the current reaches zero-state current I_{Lf_zs}. At this instant, the second switch 120 is turned OFF with quasi-ZVS. The current may transition to the bypass switch 141 and may be in that state, t0, for the remainder of that switching cycle. In the selected operating mode, I_{Lf_zs} may ensure ZVS turn-on of the first switch 110, which may not occur or be possible in conventional continuous conduction mode (CCM) and discontinuous conduction mode (DCM) of operations.

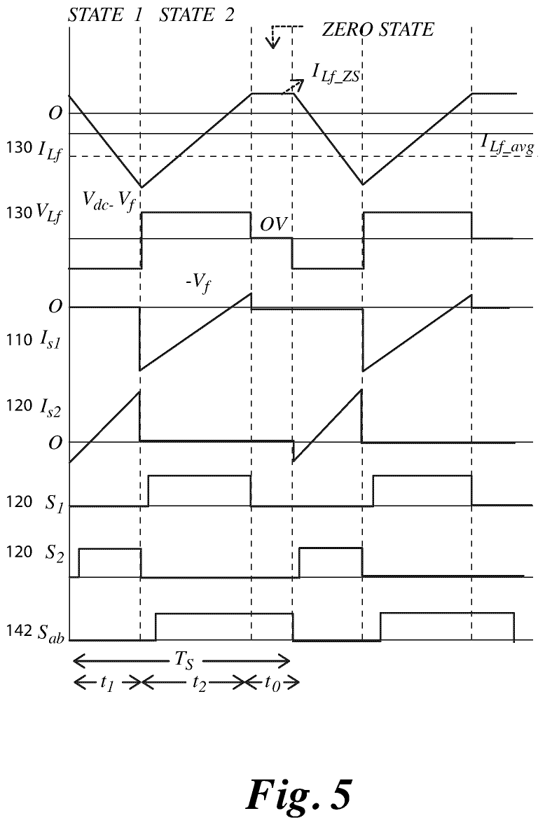

The operating waveforms for reverse power flow (power flowing from V_{dc} to V_{f} or buck mode) is shown in FIG. 5. Compared to forward power flow, the polarity of the average inductor current changes to negative and the polarity of the zero-state current I_{Lf_zs} changes to positive. In this case, I_{Lf_zs} is enabling ZVS turn ON of the second switch 120.

In a single-phase converter system according to one embodiment, such as the converter system 7000, two converters 100 may be operated in a similar way but with current references of opposite polarity. It is shown in FIG. 5 that the operating principle applies for both positive and negative power flow. As a result, ZVS may be achieved over the four-quadrants in a single-phase converter. Similarly, the operating principle can be extended to 3-phase, 3-wire, or 4-wire systems.

As described herein in accordance with one embodiment, all the switches including the bypass switching circuit 140 (e.g., the auxiliary switch) may achieve soft switching. The dv/dt can be controlled by adding a capacitor (e.g., a small capacitor such as 5-100 nF) across the bypass switching circuit 140 (e.g., including bypass switches 141, 142). The inductor 130 may operate with 200% peak-to-peak ripple compared to the mean current in the inductor 130. In a conventional converter, the ripple is typically 10-20%. For the converter 100 in one embodiment, operating with high current ripple (e.g., greater than 20%, 50%, or 100%, or at 200%) allows a reduction in the value of the inductor 130 by 10-20× compared to a conventional converter. The inductor 130, however, may be subjected to twice the peak current of the conventional converter. As a result, the reduction in inductor size, which depends on LI², may be 3-5×. Increased current ripple implies increased filter capacitor size. However, in one embodiment of the present disclosure, the converter 100 may be operated with a fixed frequency, which enables use of interleaving to reduce the filter capacitor size. The fixed frequency approach also can simplify EMI filter design.

### A. Inductor 130 Configuration

The configuration of the inductor 130 of the converter 100 may impact performance of the converter 100. Specifically, configuration of the inductor 130 may be determined to ensure a target current is delivered even during a worst-case condition where the difference between DC bus voltage at the DC output 150 and voltage of the filter capacitors 102, 104 is minimal. Accordingly, the configuration of the inductor 130 may depend on the values of minimum DC bus voltage V_{dc_min}, peak filter capacitor voltage V_{f_pk}, switching frequency Fₛ, and target maximum average current in the inductor I_{avg,max}. Based on the identified parameters, the following equation 4 may be utilized in one embodiment to configure the inductor 130 (L_{f}) for the converter 100:

$${L}_{f} = \frac{( {V}_{dc \_ min} - {V}_{f \_ pk} ) * ( {V}_{f \_ pk} )}{{I}_{max} {V}_{dc \_ min} {F}_{s}} , \qquad ( 4 )$$

where Iₘₐₓ=2*(I_{avg,max}−I_{Lf_zs}) is the maximum current in the inductor.

### B. Zero State Current, I_{Lf_zs}

Selecting for zero state current may ensure ZVS turn on the main switch (e.g., the first and/or second switches 110, 120 of the half-bridge 101) while accounting for the dead time, t_{d}. The first condition to ensure ZVS is that the energy stored in the inductor 130 may be larger than the energy required to charge the equivalent device output capacitance.

$${L}_{f} {I}_{LF \_ ZS}^{2} > {C}_{equiv} {V}_{dc}^{2} , \qquad ( 5 )$$

where C_{equiv} is the sum of device capacitances of top and bottom switches 110, 120 and any external capacitance added to control dv/dt.

The second condition for selecting I_{Lf_zs} may be related to the dead time. Considering the worst case di/dt of the inductor current

$$di / {dt}_{max} = max ( \frac{( {V}_{f} ) max}{{L}_{f}} , \frac{( {V}_{dc} - {V}_{f} ) max}{{L}_{f}} )$$

the time available for the turn on the main switch (e.g., the first and/or second switches 110, 120 of the half-bridge 101) is

$$\frac{abs ( {I}_{Lf \_ zs} )}{di / {dt}_{max}} .$$

The dead time may be constrained to be less than the time available as given by the following equation.

$$abs ( {l}_{Lf\_zs} ) > {t}_{d} * di / {dt}_{max} , \qquad ( 6 )$$

$$where di / {dt}_{max} = \frac{{( {V}_{dc} - {V}_{f} )}_{max}}{{L}_{f}}$$

C. Filter capacitor 102, 104, C_{f}

Configuration of the filter capacitor 102, 104 may be to limit the voltage ripple to be less than the allowed voltage ripple, V_{pp_max} and is given by the following equation:

$${C}_{f} > ( \frac{{I}_{max} - {I}_{max \_ avg}}{2} ) * \frac{{T}_{s}}{2} * \frac{1}{{V}_{pp\_max}} \qquad ( 7 )$$

The present disclosure is not limited to the filter capacitor arrangement depicted in the illustrated embodiments. That is, the filter capacitors 102, 104 may be arranged differently relative to the inductor 130 depending on the application. For instance, the capacitor 102 may be absent while the capacitor 104 may remain, or the capacitor 104 may be absent while the capacitor 104 may remain. As another example, the capacitor 102 may be absent while the capacitor 104 may remain but, instead of being connected to the common node 152, the capacitor 104 may be connected to the input node 111.

### II. Modularization

Turning to the illustrated embodiment of FIG. 3, a plurality of converters 100 may be arranged to provide DC power at the DC output 150 based on AC power within a converter system 3000. For purposes of discussion, the plurality of converters 100 are labeled 1, 2, 3—although more or fewer converters 100 may be provided. The plurality of converters 100 may be configured to receive AC power from multiple AC power sources 10, which are also labeled 1, 2, 3 for purposes of discussion. The power sources 10 in the illustrated embodiment of FIG. 3 may correspond to separate phase legs of a single source, such as a 3-phase AC power source, and/or the power sources 10 may correspond to separate AC sources.

In the illustrated embodiment, the converters 100 are substantially the same, with the common nodes 152 and the DC outputs 150 of each of the converters 100 being connected together to supply DC power, based on AC power, across the DC output 150 and common node 152. A capacitor 12, similar to the arrangement described in conjunction with FIG. 2, may be provided across the DC output 150 and the common node 152 to filter the DC power output.

Yet another arrangement of multiple converters 100 is shown in FIG. 7 as part of a converter system 7000. A plurality of converters 100 are arranged to provide DC power at the DC output 150 based on AC power from an AC power source 10. Similar to FIG. 3, for purposes of discussion, the plurality of converters 100 are labeled 1, 2 though more or fewer converters may be provided. The plurality of converters may be configured to receive AC power from an AC power source 10, which is a single-phase AC power source.

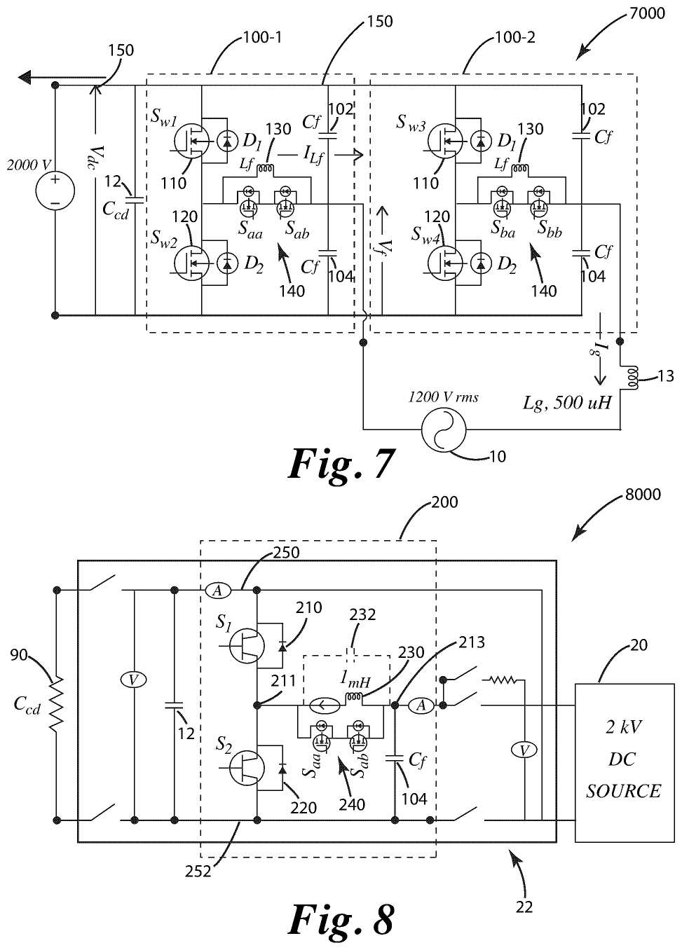

In the illustrated embodiment of FIG. 8, a test system 8000 is provided for testing a converter 200 that is similar in many respects to the converter 100 described herein. For instance, the converter 200 includes first and second switches 210, 220 provided between a DC output 250 and a common node 252, similar to the first and second switches 110, 120 of the converter 100. A supply node 211 is provided to which both the first and second switches 210, 220 are electrically coupled and from which the first and second switches 210, 220 receive power.

The converter 200 also includes an inductor 230 provided between the supply node 211 and an input 213. This inductor 230 may be selectively bypassed by a bypass circuit 240, which is similar to the bypass circuit 140. Bypassing of the inductor 230 may be conducted according to one or more embodiments described herein.

The test system 8000 may include a DC load 90 and a capacitor 12 similar to the converter systems 2000, 3000, 7000. The test system 8000, however, includes a power supply 20 and an inverter circuit 22 operable to supply AC power to the input 213 of the converter 200.

### III. Control Methodology

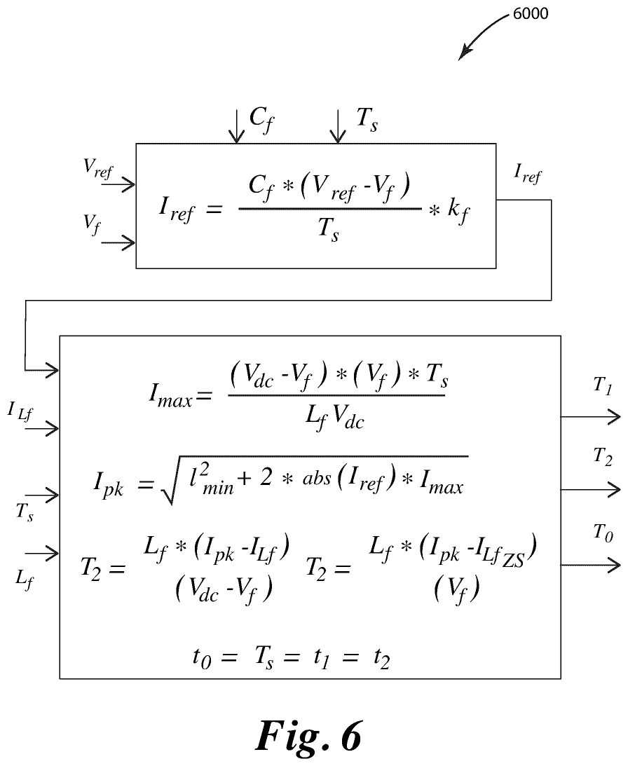

The controller 160 of the converter 100, 200 may control operation of the switching circuitry (e.g., the half-bridge circuit 101) and the bypass switching circuit 140 in a variety of ways depending on the application. A control methodology 6000 according to one embodiment may involve dead-beat model predictive control as depicted in FIG. 6.

In the illustrated embodiment, the operating mode of the converter 100 involves the inductor current having a high ripple. Within each switching cycle, the inductor current may be controlled to reach I_{Lf_zs} at the end of the two active states. A dead-beat model predictive control (DB-MPC) methodology may be utilized to generate cycle-by-cycle control of inductor current I_{Lf} of the inductor 130. In DB-MPC, the control methodology 6000 may be used to generate duty cycles for all the switches (e.g., the half-bridge switches 110, 120 and the bypass switching circuitry 140). The model of the control methodology 6000 for the current control loop may be inductor 130. For a target average current I_{ref} and the measured inductor current I_{Lf}, the timings for each state of the switches can be derived using equations 1 and 2:

$${t}_{1} = \frac{{L}_{f} * ( {I}_{pk} - {I}_{Lf} )}{( {V}_{dc} - {V}_{f} )} , \qquad ( 1 )$$

$${t}_{2} = \frac{{L}_{f} * ( {I}_{pk} + abs ( {I}_{Lf \_ ZS} ) )}{( {V}_{f} )} ,$$

$${t}_{0} = {T}_{s} - {t}_{1} - {t}_{2}$$

$$where {I}_{p k} = \sqrt{{I}_{Lf \_ zs}^{2} + 2 * abs ( {I}_{ref} ) * {I}_{max}} , {I}_{max} = \frac{( {V}_{dc} - {V}_{f} ) * ( {V}_{f} ) * {T}_{s}}{{L}_{f} {V}_{dc}} ,$$

V_{dc} is the DC bus voltage for the DC output 150, V_{f} is the filter capacitor voltage, I_{Lf_zs} is the desired current during the zero state and Tₛ is the switching time period.

If I_{ref} is negative,

$${t}_{1} = \frac{{L}_{f} * ( {I}_{pk} + {I}_{Lf} )}{( {V}_{f} )} , \qquad ( 2 )$$

$${t}_{2} = \frac{{L}_{f} * ( {I}_{pk} + abs ( {l}_{Lf \_ zs} ) )}{( {V}_{dc} - {V}_{f} )}$$

In the case of filter capacitor voltage control, the control methodology may focus instead on the filter capacitor. The voltage control loop may generate the current reference for the current loop.

$${I}_{ref} = \frac{{C}_{f} * ( {V}_{ref} - {V}_{f} )}{{T}_{s}} * {k}_{f} \qquad ( 3 )$$

where V_{ref} is the filter capacitor desired voltage, and C_{f} is the filter capacitor value. K_{f} is the factor (0<K_{f}<1) determining how quickly filter capacitor is reached. It may be selected to be around 0.3 to reach the target value in 4-5 cycles.

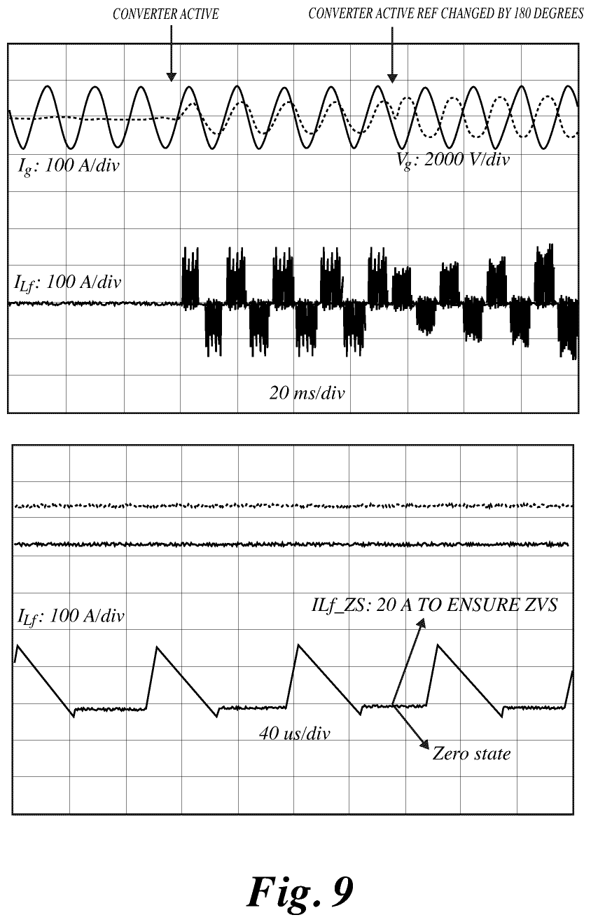

With regard to the converter system 7000 in the illustrated embodiment of FIG. 7, the converter 100 may be configured for use in a single-phase system. Although it is to be understood that the converter 100 may be configured in a variety of ways, the converter 100 in FIG. 7 is configured according to the following parameters: L_{f}=55 uH, C_{f}=40 uF, I_{Lf_zs}=20 A and Fₛ=10 kHz. The DC bus or DC output 150 may be maintained at 2000 V and the grid voltage is set at 1200 Vrms. Initially the grid may deliver reactive power to the filter capacitors 102. Then, the converter 100 is activated to deliver active power. The current reference for the converter 100 may be in phase with the grid voltage output (e.g., the output from the AC power supply 10). The grid current may be lagging the voltage because of the reactive power to be delivered to the filter capacitor 102, 104 from the AC power supply 10. As shown in FIG. 9, the converter 100 can deliver sinusoidal currents. The current reference is later changed by 180 degrees to absorb active power. The immediate change in inductor current through the inductor 130 can be observed. The <2 cycle response is due to the DB-MPC controls employed. In the zoomed-in waveforms for the I_{Lf}, the large current ripple and the small bias current of 20 A can be observed. The bias current may ensure ZVS of all switches as described herein according to one or more embodiments.

Turning to the converter system 8000 depicted in FIG. 8, a 2 kV DC half-bridge converter 100 operating in boost mode is shown for purposes of discussion.

The main switches or first and second switches 210, 220 are 3300 V, 450 A, Si IGBTs from Infineon. The bypass switching circuit 240 may include two 3600 V 50 A Si IXYS MOSFETs connected in common emitter fashion. The bypass switching circuit 240 is 30× smaller in size and cost compared to the main switches. The boost converter may be designed to deliver 240 kW. The filter inductor 230 may be 1 mH, 450 A to deliver 200 A average current while operating at 1200 V on the low voltage side and 1800 V on the boost side, and with a switching frequency of 1 kHz (as per Eq. 4). The filter capacitors 104 on either side are chosen to be 720 uF to maintain peak-to-peak ripple at <5%. This configuration is shown as a test setup including a 2 kV DC source 20 and a resistive load 90.

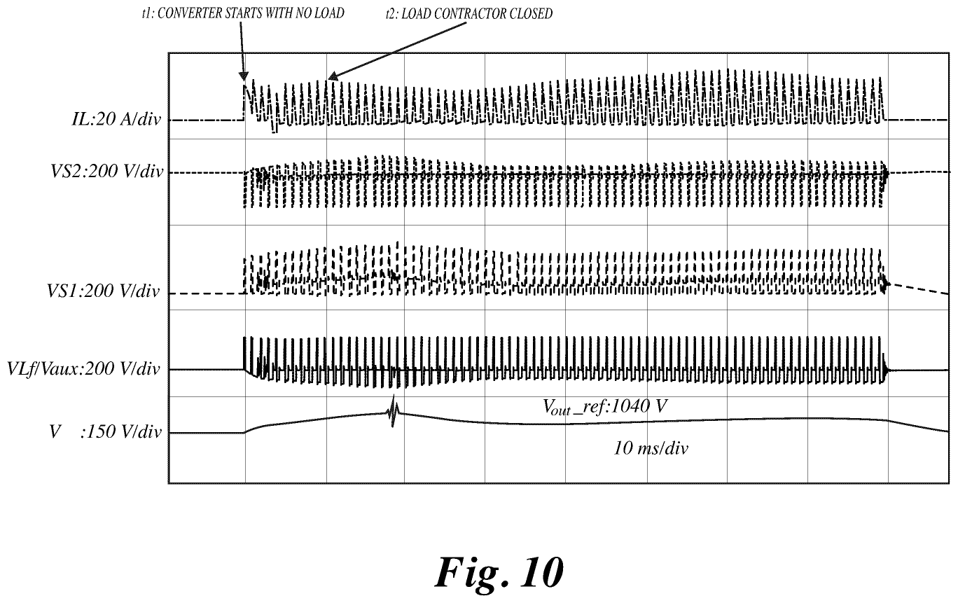

Several characteristics of operation for the converter system 8000 are shown in FIG. 10. The inductor current is shown in plot 1, voltage across switch S2, 220 is shown in plot 2, voltage across switch S1, 210 is shown in plot 3, voltage across the inductor 230 and the bypass witching circuit 240 is shown in plot 4 and output voltage across the load 90 is shown in plot 5. The objective of the converter controls may be to maintain 1040 V on the boost side. Initially, the capacitors 204 on either terminal are pre-charged to 800 V. At t1, the converter 200 may start operating and charge the output capacitor 12 to 1040 V. At this instant, there is no load. At t2, the load 90 may be connected and the output capacitor 12 starts discharging. A drop in Vₒᵤₜ at the DC output 250 in this instant can be observed. The converter 200 may act to bring the output capacitor 12 voltage to 1040 V within 40 ms. The large ripple in the inductor current and constant negative current of −5 A during the zero state can be observed. It can be seen that the ability of the DB-MPC control methodology may achieve cycle-by-cycle current control to reach zero-state current of −5 A even under varying active states.

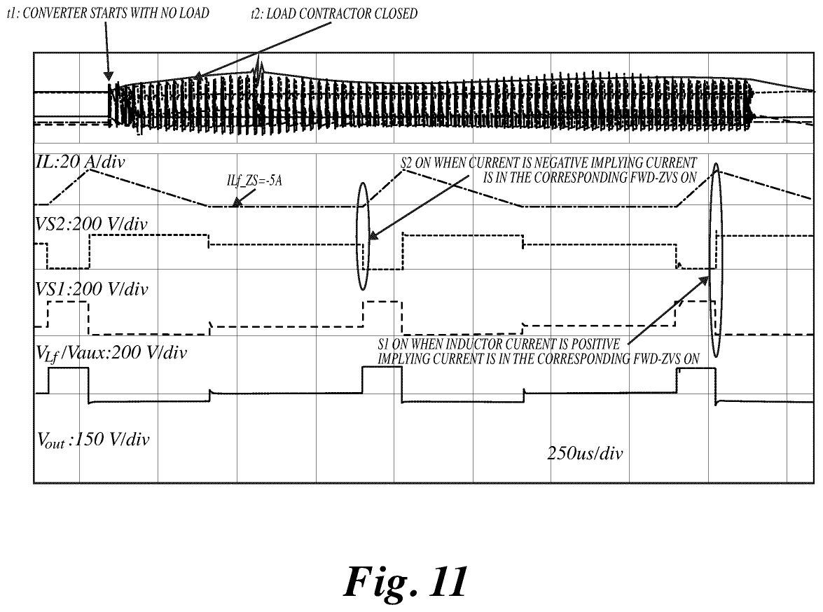

The zoomed in waveforms of FIG. 10 are shown in FIG. 11. To understand ZVS operation, consider the inductor current for the converter 200 in FIG. 8. When the inductor current is positive and the second switch 220 and the bypass switching circuit 240 are off, inductor current may flow through the FWD of the first switch 210. This implies that the first switch 210 can have ZVS turn-on if it is switched when inductor current is positive. When the inductor current is negative and the first switch 210 and the bypass switching circuit 240 are off, current may flow flow through the FWD of S1. This implies that the first switch 210 can have ZVS turn-on if it is switched when inductor current is negative. In FIGS. 10 and 11, it can be seen that the first switch 210 is turned on when the inductor current is positive and the second switch 220 is being turned on when the inductor current is negative, which implies ZVS turn-on of the first and second switches 210, 220 may be achieved. The bypass switching circuit 240 may actually be turned right along with the first switch 210. At this instant, the inductor current is flowing in the FWD of the first switch 210 and hence the bypass switching circuitry 240 may achieve both ZCS and ZVS.

The second switch 220 has ZVS turn-on because a small negative current is maintained in the inductor 230 during the zero state. The zero state also enables operating the converter 200 with fixed frequency while maintaining negative current to achieve ZVS turn-on. In practice, the inductor current may reach-5A during the zero state, indicated by V_{Lf}=V_{bypass}=0V. The current during this period may be circulating between the inductor 230 and the bypass switching circuit 240.

As described herein, a capacitor 132, 232, Cₛ may be provided across the inductor 130, 230, and thereby the bypass switching circuit 240, to achieve dv/dt control. A double-pulse test may be conducted on the first switch 110 in the form of a 3.3 kV 450 A Si device, with the second switch 120 being absent.

The capacitor 132, 232, Cₛ may effectively increase the device output capacitance. With respect to the converter system 2000, initially, the first switch 110, S1 is turned on and the current starts increasing in the inductor 140. During this period, the voltage across Cₛ is equal to V_{dc}. When S1 is turned off, the inductor current discharges Cₛ and only when Cₛ is fully discharged, the inductor current transitions to the diode. The value of the inductor current and the value of Cₛ may determine the dv/dt. The reduction in dv/dt through addition of Cₛ may also reduce turn-off loss.

It is noted that the addition of the capacitor 132, Cₛ may increase turn-on loss of S1. To avoid this increase, the first switch 110, S1 may be turned-on under ZVS condition, which is conducted by operation of the bypass switching circuit 140.

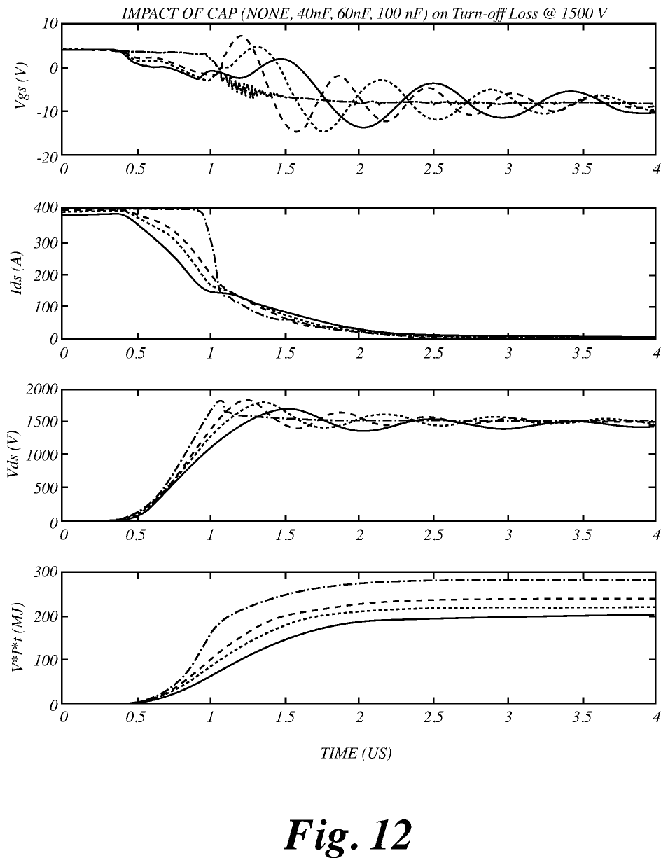

The impact of Cₛ on turn-off loss and dv/dt according to one embodiment is shown in FIG. 12. The first plot is the gate-emitter voltage of the first switch 110, the second plot is the current of the first switch 110, the third plot is the voltage of the first switch 110, and the fourth plot is the integral of the voltage and current of the first switch 110 indicating the switching loss. The tests are conducted at 1500 V and 400 A with four different values of Cₛ: none, 40 nF, 60 nF, 100 nF. As shown in FIG. 12, the turn-off loss reduces from 290 mJ with no capacitor to 200 mJ with 100 nF, about 40% reduction. The reduction in dv/dt can also be seen.

The reduction in switching loss with increased Cₛ has diminishing returns. This is because of the minority carriers in the IGBT as observed in the long tail current in the current plot of the first switch 110. The reduction in switching loss with Cₛ may be much higher with SiC MOSFETs as it does not have the tail-current issues.

For purposes of discussion and efficiency analysis, the half bridge converter 200 shown in FIG. 8 may be analyzed. To calculate losses for the base case, the converter 200 may be operated in CCM with V_{f}=1200 V and V_{dc}=1800 V and 200 A. The filter inductor 230 may be selected so that the current ripple is <10%. For a 3.3 kV, 450 A, Infineon device, the turn-on loss at 1800 V, 200 A, 125 deg. C. may be 350 mJ, the turn off loss may be 300 mJ, and the reverse recover loss may be 350 mJ. Therefore, the total switching loss may be 1000 W at 1 KHz Fₛ. The Vce and V_{f} drop may be around 2.2 V, resulting in conduction loss of 440 W. The total loss of the half bridge 200 operating in continuous conduction mode (CCM) (e.g., conventional operation without the bypass switching circuit 240) may be 1440 W.

Operating the converter 200 in discontinuous conduction mode (DCM) (e.g., with an inductor 230 of 1 mH) may increase efficiency. The inductor 230 may have a maximum peak current of 400 A. The switching loss may be the turn off loss of the first and second switches 210, 230. At 1800 V and 400 A, the turn off loss may be 550 W. The forward characteristics of diode and IGBT can be represented by a constant voltage drop of 1.2 V, and a resistance of 4 mΩ at 125 deg. C. The inductor current has an average component of 200 A and an RMS component of 230 A. Accordingly, the conduction loss may be calculated to be 454 W, and the total loss of the converter 200 may be 1004 W (much less than CCM mode operation).

In operating the converter 200 in a ZSM mode, the operation is similar to the DCM mode except the optional capacitor 232 is provided across the inductor 230. The capacitor 232 as noted herein can reduce the turn-off loss. As shown in FIG. 8, the turn off loss at 1500 V and 400 A can be reduced from 290 mJ with no capacitor to 200 mJ with 100 nF. The reduction is about 40%. Assuming I_{Lf_zs}=20 A and minimum of 5% time is spent in the zero state, the inductor peak current may increase to 440 A. The turn off loss at 1800 V, 445 A, with the 40% reduction due to the capacitor 132, may be 367 W. The conduction loss may increase by 5% to 480 W. The conduction loss in the bypass switching circuitry 240 may be caused at least in part by a 4 V drop including the switch and the diode for 5% of the switching cycle, resulting in a loss of 20*4*0.05=4 W. The total loss in the converter 200 may be 851 W (again much less than CCM mode operation and less than DCM mode operation without the capacitor 232).

Moving from CCM to DCM may reduce the total loss by 30%, and then moving to the ZSM mode may result in a further 15% reduction. Operation according to one embodiment can result in loss reduction of 40% compared to conventional converter construction and operation.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A converter module comprising:
a half bridge including a first switch and a second switch;
a filter inductor electrically connected at the output of the half bridge; and
an auxiliary switching circuit electrically connected in parallel to the filter inductor, the auxiliary switching circuit including a pair of switches having their emitters electrically connected to each other or having their collectors electrically connected to each other, wherein the auxiliary switching circuit is configured to cause, when the converter module is operated using fixed-switching frequency, zero-voltage switching of the first switch or the second switch or both.

2. The converter module of claim 1 comprising a first filter capacitor electrically connected in parallel across the first switch and the filter inductor.

3. The converter module of claim 1 comprising an input operable to receive power from a power source, wherein the input is operably coupled to the half bridge to supply power thereto, wherein a load is operably coupled to the half bridge to receive power therefrom.

4. The converter module of claim 2 comprising a second filter capacitor electrically connected in parallel across the second switch and the filter inductor.

5. The converter module of claim 1 wherein the output is operable to receive power from a power source via the filter inductor and the auxiliary switching circuitry, and wherein the converter is operable to supply power across the first and second switches of the half-bridge.

6. The converter module of claim 5 wherein the converter is bidirectional such that the output of the half-bride is operable to receive and supply power.

7. The converter module of claim 1 wherein the half bridge is operable to receive AC power from a power source, and wherein the half bridge is operable to generate DC power.

8. The converter module of claim 1 wherein each of the switches includes:
a MOSFET or an IGBT; and
an antiparallel free-wheeling diode.

9. The converter module of claim 1 wherein the converter is controlled using a dead-beat predictive model.

10. The converter module of claim 9 wherein the converter is controlled according to a dead-beat predictive module once every switching cycle.

11. The converter module of claim 1 wherein the converter is operated according to a buck mode or a boost mode.

12. A 1-phase converter comprising two cascaded copies of the converter module of claim 1.

13. The 1-phase converter of claim 12 wherein the half bridge of each of the converters is operable to receive AC power from a power source, and wherein the half bridges are operable to generate DC power.

14. A 3-phase converter comprising three copies of the converter module of claim 1, wherein converters are electrically connected in parallel to each other.

15. The 3-phase converter of claim 14 wherein the half bridge of each of the converters is operable to receive AC power from a power source, and wherein the half bridges are operable to generate DC power.

16. A converter module for converting AC power to DC power, the converter module comprising:
a half bridge including a high side switch and a low side switch, the high side switch being operably coupled to the low side switch via a first node, the half bridge operable to at least one of receive and supply the DC power;
an inductor electrically coupled to the first node of the half bridge, the inductor operable to at least one of direct the AC power from a power source to the first node and supply the AC power from the first node to a load; and
an auxiliary switching circuit electrically connected in parallel to the inductor, the auxiliary switching circuit including a first switch operable to facilitate selective bypassing of the inductor.

17. The converter module of claim 16 wherein the converter module is configured such that the half bridge is operable to supply the DC power based on power received via the first node, and wherein, the auxiliary switching circuit is operable facilitate selective bypassing of the inductor to direct the AC power from the power source to the first node.

18. The converter of claim 16 wherein the auxiliary switching circuit includes a second switch electrically connected in series with the first switch, wherein a source of each of the first and second switches are connected together.

19. The converter of claim 16 wherein the auxiliary switching circuit includes a second switch electrically connected in series with the first switch, wherein the first and second switches are connected in one of a common collector configuration or a common emitter configuration.

20. The converter of claim 16 wherein the auxiliary switching circuit is configured to cause, when the converter module is operated using fixed-switching frequency, zero-voltage switching of at least one of the high and low side switches of the first half bridge.

21. The converter of claim 16 comprising a controller configured to direct operation of the first half bridge and the auxiliary switching circuit.

22. The converter of claim 16 comprising:
a second half bridge including a second high side switch and a second low side switch, the second high side switch being operably coupled to the second low side switch via a second node;
a second inductor electrically coupled to the second node of the second half bridge, the second inductor operable to direct the AC power from the power source to the second node;
a second auxiliary switching circuit electrically connected in parallel to the second inductor, the second auxiliary switching circuit operable to facilitate selective bypassing of the second inductor to direct the AC power from the power source to the second node;
a third half bridge including a third high side switch and a third low side switch, the third high side switch being operably coupled to the third low side switch via a third node;
a third inductor electrically coupled to the third node of the third half bridge, the third inductor operable to direct the AC power from the power source to the third node;
a third auxiliary switching circuit electrically connected in parallel to the third inductor, the third auxiliary switching circuit operable to facilitate selective bypassing of the third inductor to direct the AC power from the power source to the third node;
wherein a low side switch, the second low side switch, and the third low side switch are connected at a common node; and
wherein a high side switch, the second high side switch, and third low side switch are connected at a DC output, whereby DC power is supplied via the common node and the DC output.

23. The converter of claim 22 wherein the second and third auxiliary switching circuits include first and second auxiliary switches connected in a common emitter configuration or a common collector configuration.
